(19) United States
(12) Patent Application Publication
(10) Pub. No.: US 2016/0068048 A1
(43) Pub. Date: Mar. 10, 2016

(54) Windscreen Frame Assembly for Passenger Service Vehicle

(71) Applicant: ALEXANDER DENNIS LIMITED, Camelon, Falkirk (GB)

(72) Inventor: Eammon Kilduff, Larbert (GB)

(21) Appl. No.: 14/778,350

(22) PCT Filed: Mar. 18, 2014
(86) PCT No.: PCT/GB2014/050853

§ 371 Date: Sep. 18, 2015

(30) Foreign Application Priority Data
Mar. 18, 2013 (GB) 1304944.0

(51) Int. Cl. B60J 1/00; B60J 1/02

(52) U.S. Cl. CPC B60J 1/007; B60J 1/02

(57) ABSTRACT

There is provided a windscreen frame assembly (100) for a passenger service vehicle (600). The windscreen frame assembly (100) is prefabricated and comprises a frame defining an aperture for receiving a windscreen. The windscreen frame assembly (100) comprises a plurality of fixing members (110, 112, 116, 118, 126, 128, 132) projecting from the windscreen frame assembly (100) and configured to align with corresponding fixing members located on a passenger service vehicle frame (200). There is provided a corresponding method of fitting a windscreen frame assembly (100) to a vehicle frame (200).

### TECHNICAL FIELD

The invention relates to the field of vehicles such as passenger service vehicles. In particular, but not exclusively, the invention relates to a windscreen frame assembly for a passenger vehicle. Further, the invention relates to, but is not limited to, a chassis for vehicles such as passenger service vehicles, as well as associated apparatus, structures, vehicles and methods.

### BACKGROUND

Passenger service vehicle assembly is a skilled job requiring input from a number of highly trained personnel. Typically, passenger service vehicles, in particular buses, are assembled on an assembly line. This process can be costly and time consuming and may also provide less accurate results due to the environment in which assembly takes place.

It is desirable to mitigate or overcome some of these issues to improve the efficiency and accuracy of passenger service vehicle assembly.

### SUMMARY

According to an aspect of the invention, there is provided a windscreen frame assembly for a passenger service vehicle. The windscreen frame assembly may be prefabricated. The windscreen frame assembly may comprise a frame defining an aperture for receiving a windscreen. The frame may comprise a ring frame. The windscreen frame assembly may comprise a ring frame defining an aperture for receiving a windscreen. The windscreen frame assembly may comprise a plurality of fixing members projecting from the windscreen frame assembly and configured to align with corresponding fixing members located on a passenger service vehicle frame. The fixing members may be configured to align the windscreen frame assembly with a vehicle frame. The alignment may be to within a predetermined tolerance.

The ring frame may comprise first and second opposing beams and first and second opposing pillars. The ring frame may define an aperture that is generally rectangular. When fitted to a vehicle frame, the first beam may be uppermost.

The fixing members may comprise a plurality of fixing plates projecting from the ring frame. The fixing plates may comprise one or more fixing holes. The fixing holes may be configured to align with corresponding fixing holes on the vehicle frame. The fixing holes may be linearly aligned with respect to each other. The fixing plates may comprise a pillar fixing plate projecting from each of the first and second pillars. The pillar fixing plates may comprise fixing holes configured to align with fixing holes in a pillar of a vehicle frame. The fixing plates may comprise one or more beam fixing plates projecting from the second beam.

The fixing holes may provide for fixing of the windscreen frame assembly to a vehicle frame. For example, the fixing holes may allow the windscreen frame assembly to be fastened to the vehicle frame with one or more fasteners, or any other suitable fixing method.

The fixing members may comprise one or more fixing struts extending from the ring frame. The fixing struts may extend from the second beam. The fixing struts may extend diagonally outwards and rearwards, with reference to a vehicle frame to which the assembly is configured to be fitted. The fixing struts may each comprise an angle plate connected to a distal end of the fixing strut. The angle plate may comprise one or more fixing holes. The angle plate fixing holes may be configured to align with corresponding fixing holes on a vehicle frame.

The fixing members may comprise a flange extending from the first beam. The flange may comprise a plurality of flange fixing holes spaced apart along the length of the flange. The flange fixing holes may be configured to align with corresponding fixing holes on a cant cross member of a vehicle frame.

It is noted that aspects of the invention may be implemented without a ring frame. For example, a windscreen frame assembly may comprise only the second beam and the first and second pillars, i.e. without the first beam.

According to an aspect of the invention, there is provided a vehicle frame comprising the windscreen frame assembly described above. The vehicle frame may be a bus vehicle frame.

According to an aspect of the invention, there is provided a passenger service vehicle comprising the windscreen frame assembly described above. The vehicle may be a bus.

The vehicle may have an overall length of about 35 feet, or less. For example, the vehicle may have an overall length of between 25 feet and 35 feet. In some examples, the vehicle may have an overall length of approximately 35 feet. Such a vehicle may be configured to provide at least 35 passenger seats. Such a vehicle may have an unladen weight of around 25,000 lbs, or less (e.g. roughly 20,000 lbs, or even less).

In other examples, the vehicle may have an overall length of approximately 30 feet. Such a vehicle may be configured to provide at least 27 passenger seats. Such a vehicle may have an unladen weight of around 22,000 lbs or less (e.g. 18,000 lbs, or even less).

The vehicle may have a front overhang (i.e. the distance from the front of the vehicle to the centre of a front axle) of around 250 cm, 230 cm or less (e.g. 226 cm). The vehicle may have a rear overhang (i.e. the distance from the rear of the vehicle to the centre of a rear axle) of around 300 cm, 275 cm or less (e.g. 271 cm).

The vehicle may comprise a longitudinally mounted engine (e.g. a six cylinder longitudinally mounted engine). Such an engine may be compliant with, for example, environmental protection agency requirements. The vehicle may be a single-deck vehicle. The vehicle may comprise at least two passenger doors. The vehicle may comprise a vertical exit exhaust. The vehicle may comprise an air conditioning system. The conditions system may be mounted on the external of the vehicle. The conditioning system may be provided in a middle region of the vehicle.

According to an aspect of the invention, there is provided a method of fitting a windscreen frame assembly to a vehicle frame. The windscreen frame assembly may be prefabricated. The method may comprise aligning the windscreen frame assembly with a vehicle frame using a plurality of fixing members. The method may comprise fixing the windscreen frame assembly to the vehicle frame using the plurality of fixing members. The method may comprise checking the alignment of the fitted windscreen frame assembly using a checking frame. The checking frame may comprise a plurality of fiducial points arranged to align with corresponding points on the windscreen frame assembly when the windscreen frame assembly is correctly aligned on the vehicle frame.

The checking frame may comprise nine fiducial points.

The method may comprise checking the windscreen frame assembly before it is fitted to the vehicle frame. Checking the windscreen frame assembly before it is fitted to the vehicle frame may be done using the checking frame. The checking frame may be positioned against the windscreen frame assembly to check it is properly aligned. The windscreen frame assembly may be considered to be properly aligned if the fiducial points of the checking frame align with corresponding points on the windscreen frame assembly.

### BRIEF DESCRIPTION OF THE DRAWINGS

Exemplary embodiments of the invention are disclosed with reference to the accompanying drawings, in which:

FIG. 1a is an isometric view of a windscreen frame assembly;

FIG. 1b is a front elevation of a windscreen frame assembly;

FIG. 2 is an isometric view of a windscreen frame assembly connected to a vehicle frame;

FIG. 3 is a flow diagram showing a method of fitting a windscreen to a passenger service vehicle;

FIG. 4 is a representation of a checking frame;

FIG. 5a is a front elevation of a checking frame being used to check the alignment of a windscreen frame assembly fitted to a vehicle frame;

FIG. 5b is a side elevation of a checking frame being used to check the alignment of a windscreen frame assembly fitted to a vehicle frame;

FIG. 6a is a side elevation of a bus; and

FIG. 6b is a front elevation of a bus.

### DESCRIPTION

Generally, disclosed herein are methods and apparatus for assembling a passenger service vehicle. Methods and apparatus disclosed relate to a windscreen frame assembly for a passenger service vehicle. In particular, methods and apparatus disclosed herein relate to a windscreen frame assembly for a bus. Throughout the remainder of this document, the term “bus” is used but it will be understood that the methods and apparatus disclosed may be used on other passenger service vehicles.

Typically, a windscreen of a bus is fitted within a frame. The windscreen frame is mounted on a vehicle frame, which, in turn, is mounted on a vehicle chassis.

A method of mounting a windscreen frame to a vehicle frame may comprise welding separate elements of the windscreen frame to the vehicle frame, in order to define an aperture, in which a windscreen may sit. A windscreen frame may comprise a top beam, a bottom beam and left and right pillars. The bottom beam may form part of a waist beam. The top beam, bottom beam and left and right pillars define an aperture, in which a windscreen may be seated and fitted.

It is noted that the terms “top”, “bottom”, “left”, “right” and any other similar relative terms used herein are a descriptive aid and need not imply any limitation on the features with which they are associated.

The inventors have appreciated that the welding of separate windscreen frame components during bus assembly on an assembly line is time consuming, expensive and may produce inaccurate results. For example, the components of the windscreen frame may not be located in the correct positions with accuracies within required tolerances. Therefore, the aperture defined by the components may not fit the windscreen to be mounted therein within the required tolerances. This may cause leaks to appear around the edges of the windscreen. Further, welding may produce variable results in terms of accuracy, particularly in an assembly line environment, which may also lead to inaccurate placement of windscreen frame components.

Further still, in an assembly line environment, the vehicle frame may be supported on a jig. However, if the vehicle frame is not uniformly supported, then it may be twisted or distorted by the jig. If the separate components of the windscreen frame are welded to the vehicle frame in such circumstances, the aperture defined by the windscreen frame will be similarly distorted when the vehicle frame is removed from the jig.

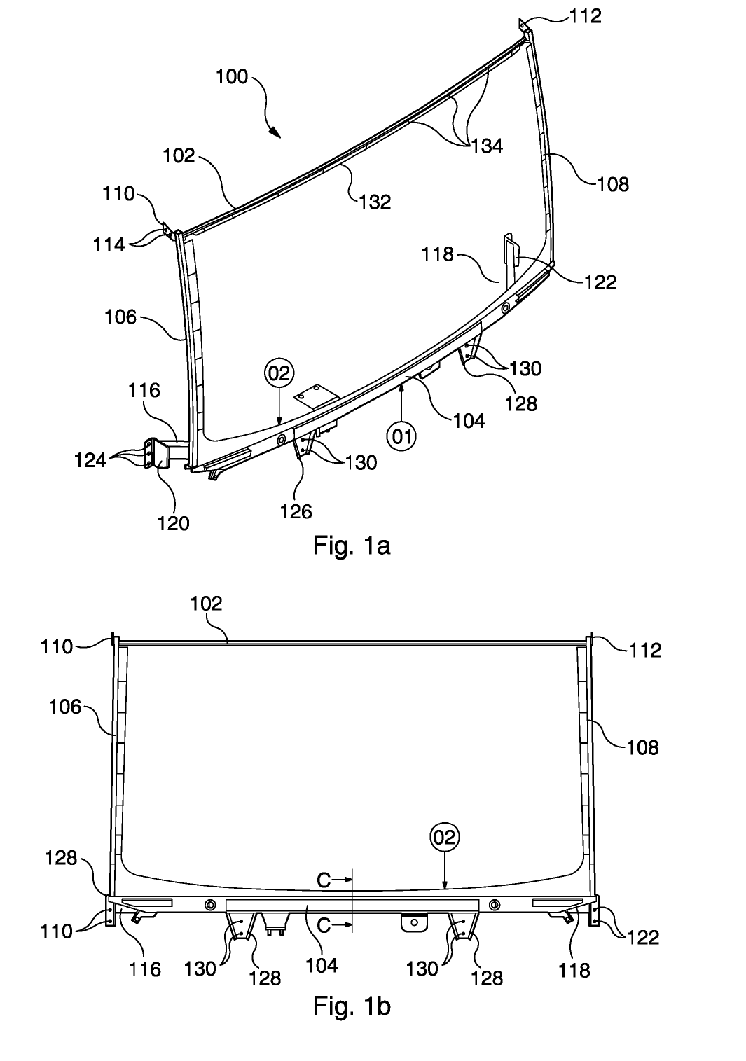

FIG. 1a shows an isometric representation of a windscreen frame assembly 100. The windscreen frame assembly 100 is a single unit that may be fitted to a vehicle frame in one operation. The exemplary windscreen frame assembly 100 of FIG. 1a is prefabricated in a workshop environment for fitting to a vehicle frame in an assembly line environment. The component parts of the exemplary windscreen frame assembly 100 have been welded together.

The windscreen frame assembly 100 comprises opposing first and second beams 102, 104 and opposing first and second pillars 106, 108. The beams 102, 104 and pillars 106, 108 form a ring frame that defines an aperture for receiving a windscreen. The aperture is generally rectangular. It is noted that a beam need not be in a horizontal configuration and a pillar need not be in a vertical configuration. The terms are used merely to aid description. When fitted to the vehicle frame, a first beam 102 is uppermost, a second beam 104 is lowermost, a first pillar 106 is on the right side of the vehicle and a second pillar 108 is on the left side of the vehicle. When fitted to the vehicle frame, the second beam 104 may form at least part of the waist rail of the vehicle.

The beams 102, 104 and pillars 106, 108 may be separate components fixed together or one or more of the beams 102, 104 and/or pillars 106, 108 may be formed of a single piece.

Pillar fixing plates 110, 112 project from the first and right pillars 106, 108. Relative to the orientation of a bus to which the windscreen frame assembly is fitted, the pillar fixing plates 110, 112 project rearwards from the first and second pillars 106, 108. The pillar fixing plates comprise one or more pillar fixing holes 114. The pillar fixing holes 114 are arranged to align with corresponding holes in the vehicle frame when the windscreen frame assembly 100 is offered up to the vehicle frame. The fixing holes 114 are predrilled during manufacture of the windscreen frame assembly 100.

Fixing struts 116, 118 extend from the second beam 104 of the windscreen frame assembly 100. The fixing struts 116, 118 extend diagonally rearwards and outwards from the assembly 100. The fixing struts 116, 118 may be welded to the second beam 104. Angle plates 120, 122 are secured to a distal end of each fixing strut 116, 118. The angle plates 120, 122 may be welded to the fixing struts 116, 118. Angle plate fixing holes 124 are located on the angles 120, 122 for fixing the windscreen frame assembly to the vehicle frame. The angle plate fixing holes 124 are arranged such that they align with corresponding fixing holes on the vehicle frame when the assembly 100 is offered up to the vehicle frame.

Second beam fixing plates 126, 128 project from the second beam 104 for fixing the windscreen frame assembly 100 to the vehicle frame. The second beam fixing plates 126, 128 project downwards from the second beam. The second beam fixing plates 126, 128 each comprise one or more second beam fixing holes 130.

The first beam 102 comprises a flange 132. The flange extends forward from the first beam 102 when the windscreen frame assembly is fitted to a vehicle frame. The flange 132 comprises a plurality of flange fixing holes 134 spaced apart along its length. The flange fixing holes 134 are configured to align with corresponding fixing holes located on a vehicle frame to which the windscreen frame assembly 100 is to be fitted.

Therefore, generally, the windscreen frame assembly 100 comprises a ring frame 102, 104, 106, 108 and a plurality of fixing members 110, 112, 116, 118, 126, 128, 132. The fixing members 110, 112, 116, 118, 126, 128, 132 comprise fixing holes 114, 124, 130, 134 arranged to align with corresponding holes located on a vehicle frame when the assembly 100 is offered up to the vehicle frame. The arrangement of the fixing holes 114, 124, 130, 134 allows the windscreen frame assembly to be correctly and accurately aligned. Further, the fixing holes may provide for fixing of the windscreen frame assembly to a vehicle frame with, for example, bolts, rivets or any other suitable fixing method and/or fasteners. This means that welding is not required on the assembly line, which increases efficiency, as the job may be carried more quickly and by less skilled personnel.

It is noted that the use of fixing holes 114, 124, 130, 134 for alignment and fixing of the windscreen frame assembly 100 to a vehicle frame are exemplary fixing types only. Other types of fixing may be used. For example, a windscreen frame assembly 100 may comprise a plurality of fixings shaped to fit into corresponding fixings located on a vehicle frame. The fixings may be male on the assembly 100 and female on the vehicle frame, or vice-versa. The fixings may be held, for example, by interference fit, or by resilient deformation of one or both of the fixings.

FIG. 1b shows a front elevation of a windscreen frame assembly 100. For illustrative purposes, the visible features of the windscreen frame assembly are referenced again in FIG. 1b.

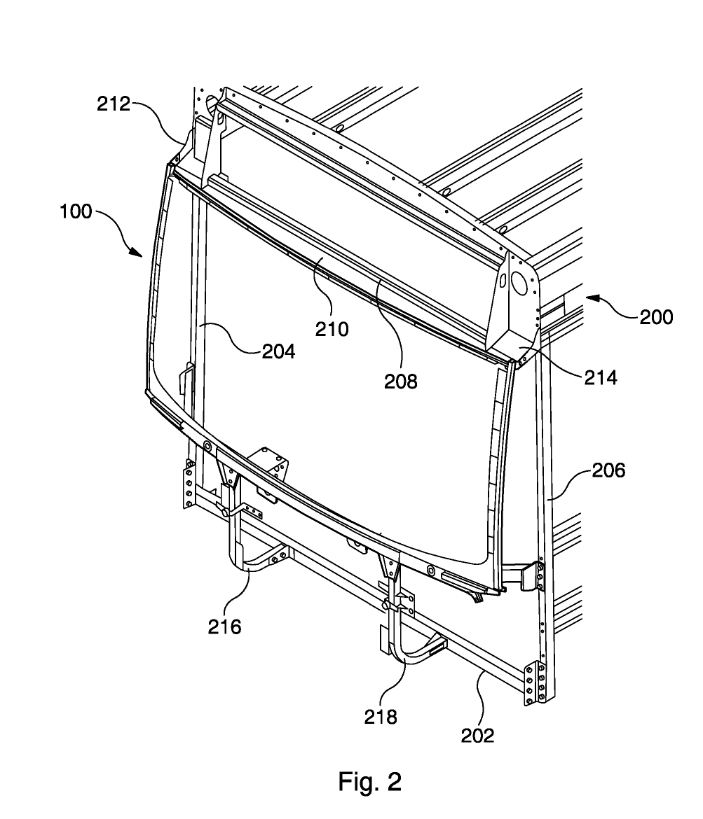

FIG. 2 is an isometric view of a windscreen frame assembly 100 connected to a vehicle frame assembly 200. The vehicle frame 200 comprises a chassis cross member 202, first and second opposing pillar members 204, 206 and a cant cross member 208.

The cant cross member 208 comprises a cant flange 210. The first beam 102 of the windscreen frame assembly 100 is configured to rest on top of the cant flange 210 such that the flange fixing holes 134 of the assembly 100 align with corresponding cant flange fixing holes in the flange 210. The cant cross member 208 further comprises cant fixing plates 212, 214. The pillar fixing plates 110, 112 of the windscreen frame assembly 100 are configured to be adjacent the fixing plates 212, 214 of the cant cross member 208 such that the fixing holes in each are aligned when the windscreen frame assembly 100 is offered up to the vehicle frame 200.

Each of the first and second pillars 204, 206 of the vehicle frame 200 comprise pillar fixing holes. The angle plates 120, 122 of the windscreen frame assembly abut the pillars 204, 206 such that the angle plate fixing holes 124 align with corresponding pillar fixing holes on the pillars 204, 206.

Chassis cross member fixings 216, 218 extend from the chassis cross member 202. The fixings 216, 218 are connected at a first end to the chassis cross member 202. The fixings 216, 218 comprise cross member fixing holes at a second end. The cross member fixing holes correspond to the fixing holes 130 in the second beam fixing plates 126, 128 of the windscreen frame assembly 100.

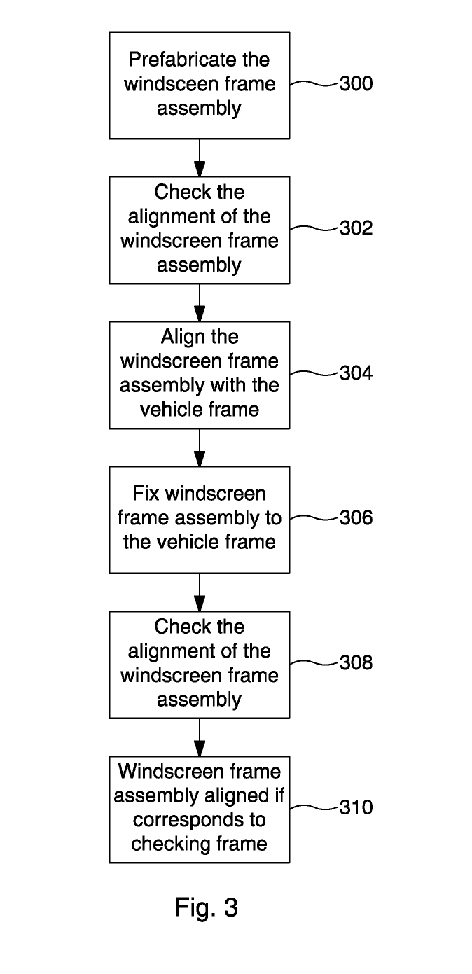

FIG. 3 shows a method of fitting a windscreen to a passenger service vehicle. The exemplary method comprises prefabricating 300 a windscreen frame assembly 100, as described above. Prefabricating the assembly 100 allows the components of the assembly 100 to be accurately fixed together in a workshop environment. However, it is noted that the windscreen assembly need not be prefabricated.

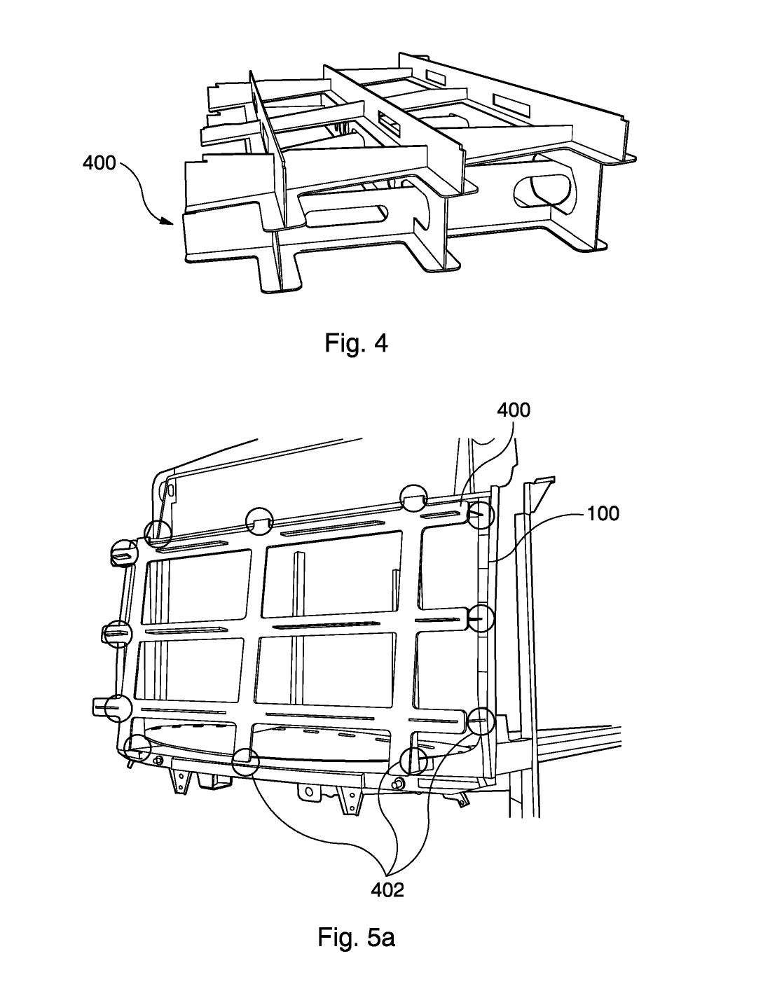

A corresponding checking frame is also constructed. The checking frame may be constructed at the same time as the windscreen frame assembly, for convenience. An exemplary checking frame 400 is shown in FIG. 4. The checking frame comprises a plurality of fiducial points. The fiducial points of the checking frame are configured to align with corresponding points on the windscreen frame assembly 100. If the assembly 100 has been manufactured so it is correctly aligned, the fiducial points will align with the corresponding points on the frame assembly 100 when the checking frame is presented to the frame assembly 100.

Accordingly, the alignment of the prefabricated windscreen frame assembly 100 is checked 302 by placing the checking frame 400 against the frame assembly 100. If the fiducial points on the checking frame 400 align with the corresponding points on the frame assembly, the frame assembly 100 is considered to be correctly aligned and may be fitted to the vehicle frame 200. If the fiducial points do not align with the corresponding points on the frame assembly 100, the frame assembly 100 may be reworked to place it in the correct alignment and checked again. The frame assembly 100 may be fitted to the vehicle frame 200 only after it has passed this alignment check.

The checked windscreen frame assembly 100 is aligned 304 with the vehicle frame 200 such that the fixing holes 114, 124, 130, 134 on the frame assembly 100 align with the fixing holes on the vehicle frame 200.

The windscreen frame assembly 100 is fitted 306 to the vehicle frame 200. This may be done using any suitable fixing, such as bolts, pins or rivets by passing the fixing through the fixing holes in the frame assembly 100 and the vehicle frame 200. As the fixing holes have been aligned, there is no requirement for a person fitting the frame assembly 100 to make any judgement regarding correct alignment. In addition, the use of a fixing, such as a bolt, pin or rivet, removes the need for a fitter to weld the frame assembly in position.

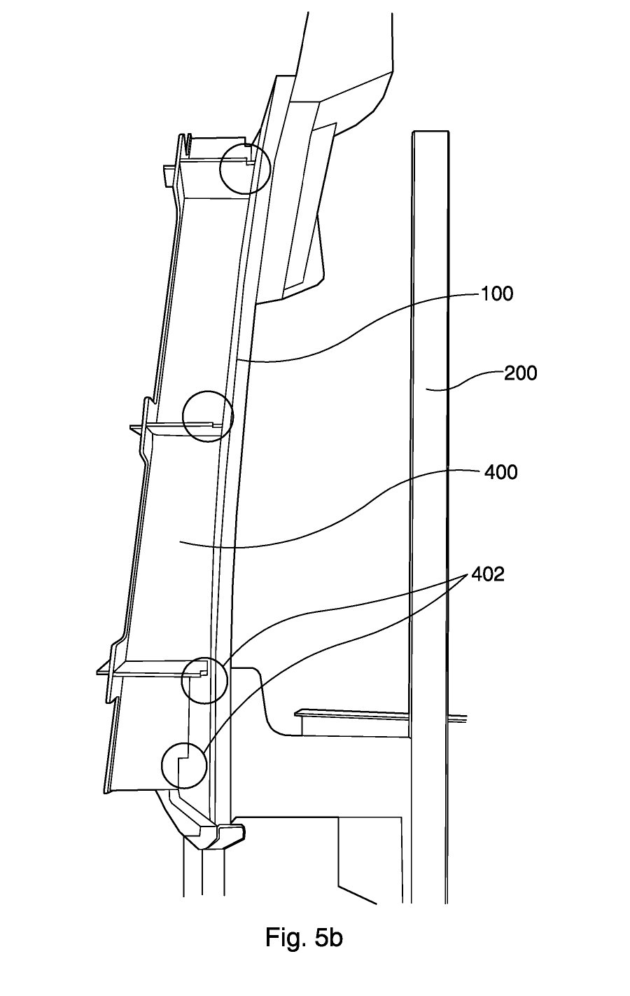

The alignment of the windscreen frame assembly 100 is checked 308. This is done using the checking frame 400. FIGS. 5a and 5b show the checking frame 400 positioned against a fitted windscreen frame assembly 100 to check its alignment. The checking frame 400 comprises a plurality of fiducial points 402. The exemplary checking frame 400 comprises nine fiducial points 402 marked with circles in FIGS. 5a and 5b. The fiducial points 402 align with corresponding points on the windscreen frame assembly 100 when it is correctly aligned and fitted to the vehicle frame 200.

If the fiducial points 402 do not correctly align with the corresponding points on the windscreen frame assembly 100, the frame assembly can be reworked until the alignment is correct. Reworking may take place while the frame assembly 100 is fitted to the vehicle frame 200.

If the fiducial points 402 are correctly aligned with the corresponding points on the windscreen frame assembly 100, the frame assembly 100 is considered to be correctly aligned 310.

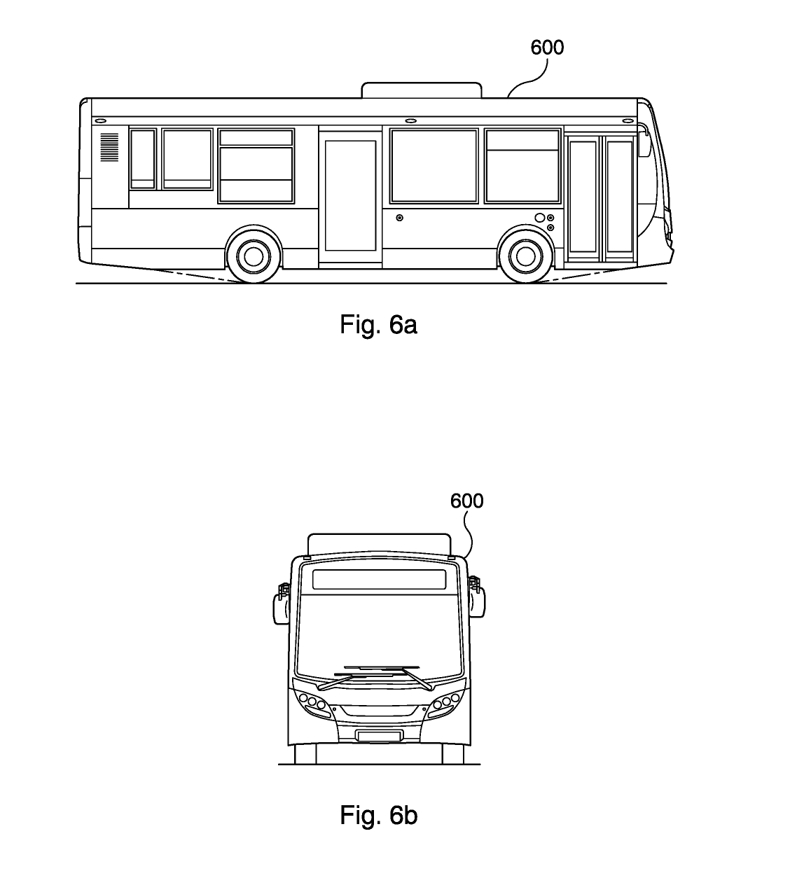

FIGS. 6a and 6b show a bus 600 with a windscreen frame assembly fitted to it.

The skilled person will be able to envisage further embodiments of the invention without departing from the scope of the invention as disclosed.

1. A windscreen frame assembly for a passenger service vehicle, the windscreen frame assembly comprising:
a prefabricated frame defining an aperture for receiving a windscreen; and
a plurality of fixing members projecting from the windscreen frame assembly and configured to align with corresponding fixing members located on a passenger service vehicle frame.

2. The windscreen frame assembly according to claim 1, wherein the fixing members may be configured to align the windscreen frame assembly with a vehicle frame to within a predetermined tolerance.

3. The windscreen frame assembly according to claim 1, wherein the frame comprises first and second opposing beams and first and second opposing pillars, defining an aperture that is generally rectangular.

4. The windscreen frame assembly according to claim 1, wherein the fixing members comprise a plurality of fixing plates projecting from the windscreen frame.

5. The windscreen frame assembly according to claim 4, wherein the fixing plates comprise one or more fixing holes configured to align with corresponding fixing holes on the vehicle frame.

6. The windscreen frame assembly according to claim 4, wherein the frame comprises first and second opposing beams and first and second opposing pillars defining an aperture that is generally rectangular, the fixing plates comprising a pillar fixing plate projecting from each of the first and second pillars.

7. The windscreen frame assembly according to claim 4, wherein the frame comprises first and second opposing beams and first and second opposing pillars defining an aperture that is generally rectangular, the fixing plates comprises one or more beam fixing plates projecting from the second beam.

8. The windscreen frame assembly according to claim 5, wherein the fixing holes provide for fixing of the windscreen frame assembly to a vehicle frame by fastening to the vehicle frame with one or more fasteners.

9. The windscreen frame assembly according to claim 1, wherein the fixing members comprise one or more fixing struts extending from the frame.

10. The windscreen frame assembly according to claim 9, wherein the frame comprises first and second opposing beams and first and second opposing pillars defining an aperture that is generally rectangular, the fixing struts extending from the second beam, with reference to a vehicle frame to which the assembly is configured to be fitted.

11. The windscreen frame assembly according to claim 9, wherein the fixing struts each comprise an angle plate connected to a distal end of the fixing strut.

12. The windscreen frame assembly according to claim 3, wherein the fixing members comprise a flange extending from the first beam.

13. The windscreen frame assembly according to claim 12, wherein the flange comprises a plurality of flange fixing holes spaced apart along the length of the flange.

14. A vehicle frame comprising the windscreen frame assembly according to claim 1.

15. A passenger service vehicle comprising the windscreen frame assembly according to claim 1.

16. A method of fitting a windscreen frame assembly to a vehicle frame, the method comprising:
prefabricating the windscreen frame assembly;
aligning the windscreen frame assembly with a vehicle frame using a plurality of fixing members; and
fixing the windscreen frame assembly to the vehicle frame using the plurality of fixing members.

17. The method according to claim 16, further comprising checking the alignment of the fitted windscreen frame assembly using a checking frame.

18. The method according to claim 17, wherein the checking frame comprises a plurality of fiducial points arranged to align with corresponding points on the windscreen frame assembly when the windscreen frame assembly is correctly aligned on the vehicle frame.

19. The method according to claim 17, wherein the method comprises checking the windscreen frame assembly before it is fitted to the vehicle frame by positioning the checking frame against the windscreen frame assembly to check if the fiducial points of the checking frame align with corresponding points on the windscreen frame assembly.
